(19) United States
(12) Patent Application Publication
(10) Pub. No.: US 2026/0127012 A1
(43) Pub. Date: May 7, 2026

(54) Method and Device for Memory Planning for Code Generation to Create Program Code for Computing an Artificial Neural Network in a Hardware Environment

(71) Applicant: Robert Bosch GmbH, Stuttgart (DE)

(72) Inventors: Benjamin Wagner, Friedrichshafen (DE); Sebastian Boblest, Duernau (DE); Duy Khoi Vo, Waiblingen (DE); Leif Sulaiman, Lund (SE); Markus Lochmann, Reutlingen (DE); Ulrik Hjort, Malmö (SE)

(21) Appl. No.: 19/378,635

(22) Filed: Nov. 4, 2025

(30) Foreign Application Priority Data
Nov. 6, 2024 (DE) 10 2024 210 661.5

(51) Int. Cl. G06F 9/445; G06F 8/30

(52) U.S. Cl. CPC G06F 9/44557; G06F 8/30

(57) ABSTRACT

A computer-implemented method for performing memory planning for code generation to generate code for computing a neural network in a hardware environment is disclosed.

This application claims priority under 35 U.S.C. § 119 to patent application no. DE 10 2024 210 661.5, filed on Nov. 6, 2024 in Germany, the disclosure of which is incorporated herein by reference in its entirety.

The disclosure relates to the implementation of a program code on a hardware environment, such as that occurring as microcontroller-controlled control devices and the like. The disclosure further relates to methods for memory planning for handling input data, output data and model parameters.

### BACKGROUND

Certain hardware environments, such as microcontrollers in control devices, require the creation of an adjusted executable program code to take into account the characteristics and limitations of the specific hardware environment. In particular, the available memory size of the working memory that can be directly accessed by the microcontroller or acceleration hardware may be limited, or memory shift or copy operations from a data memory, such as flash or external memory, to the working memory may be particularly complex due to hardware constraints.

The calculation steps for computing corresponding network layers of neural networks can require considerable memory, since for each calculation step an input data block, a model parameter block, and an output data block must be retrieved and stored in the working memory in a form that can be used by the microcontroller.

During memory planning, existing code generators determine in which region of the working memory the data blocks required for each calculation step are stored. During memory planning, in addition to assigning the input data blocks, output data blocks, and, if necessary, the model parameters to memory spaces of the working memory, the data generated during the calculation in a calculation step is also assigned a corresponding memory space.

Conventional code generators for neural networks do not usually assume limited working memory and typically allocate distinct memory spaces for storing the input data blocks, network parameter blocks, and output data blocks for each of the successive calculation steps. Until now, it has therefore been common practice to distribute the model parameters freely in the available memory in order to minimize the total memory requirement. However, this approach can result in the model parameters having to be copied section in sections into different memory spaces of the working memory before the calculation step is executed.

In particular, copying memory spaces from the data memory to a working memory as well as between memory spaces in the working memory are generally time-consuming memory operations, so that memory planning must aim to reduce the total computing time caused by the execution time of memory operations.

To reduce the maximum required working memory, a tiling algorithm can be used in which the calculation of a layer of a neural network is divided into separate successive individual calculation steps. Tiling is suitable for element-by-element operations, convolutional layer calculations, pooling layer calculations and the like. The partial results of the separate calculations are then combined again in a final concatenation step.

Tiling has an influence on memory planning, as the input data and/or model parameters of the layer to be calculated are loaded into the working memory section by section for the successive calculation steps and are discarded again after the individual calculation step has been completed, so that the total maximum memory requirement for the working memory for computing all layers of the neural network can be reduced, so that tiling can be used in particular on systems with limited working memory. However, splitting the calculation steps for certain layers of a neural network into individual calculation steps during tiling requires an increased number of memory operations to copy a model parameter block into the working memory for each of the separate individual calculation steps. This considerably increases the number of memory operations when tiling is used.

It is the object of the present disclosure to provide a method for performing memory planning for code generation for creating a code for computing artificial neural networks in a hardware environment, in which the number of memory operations can be reduced.

### SUMMARY

This object is achieved by the method for performing memory planning for code generation of a code for computing layers of a neural network in a hardware environment according to description set forth below, as well as by the device also according to the description set forth below. Further embodiments are specified in the description set forth below.

According to a first aspect, there is provided a computer-implemented method for performing code generation memory planning to determine a code for computing a neural network in a hardware environment, comprising the steps of (i) providing successive calculation steps of network layers of the neural network, wherein for each calculation step the size of an input data block, an output data block and, depending on the type of calculation step, one or more model parameter blocks is determined, wherein the one or more model parameter blocks have model parameters for a respective calculation step, (ii) determining at least one rule for memory planning for a specific calculation step, which uses model parameters and for which a tiling calculation step is to be provided, wherein the tiling calculation step provides for performing a tiling for the specific calculation step in a plurality of individual calculation steps for processing the input data of a respective section of the input data block, wherein the rule specifies that the model parameters for all individual calculation steps are stored in a defined memory space, (iii) performing memory planning, in which the memory space of the respective input data block, output data block, and model parameter block is determined in the working memory for each calculation step, taking into account the determined rules, and performing code generation, wherein the model parameter block is copied into the working memory only before executing the first individual calculation step, and the calculations of the remaining individual calculation steps are performed using the model parameters in the model parameter block.

Furthermore, performing memory planning may comprise applying an optimization method that takes into account the determined rules and, if necessary, additional rules, whereby the target function considers minimizing the total memory requirements in the working memory.

The individual computation steps for computing the computation layers of a neural network are usually computed serially on a hardware environment. This means that the generated code specifies an order for the hardware environment in which the input data is processed and the output data of the respective calculation step is generated. Each calculation step takes the input data from one or more input data blocks and stores the resulting output data in one or more output data blocks. Input data block and output data blocks represent memory spaces of the working memory which are arranged within a contiguous address space.

Depending on the calculation steps that must be performed to calculate a neural network, memory operations often occur between the actual layer calculations, which involve copying to the working memory or moving memory spaces within the working memory. The memory operations are often time-consuming and also involve a significant amount of time that does not depend on the size of the memory space to be copied or moved.

For certain calculation steps of the neural network, which have a high memory requirement, tiling can be used, in which the calculation of a layer of a neural network is divided into separate successive individual calculation steps. Tiling is suitable for element-by-element operations, convolutional layer calculations, pooling layer calculations and the like. The partial results of the separate calculations are then reconnected by a final calculation of a concatenation layer.

If a tiling is conventionally provided for a calculation step of a calculation of a specific layer of a neural network at least one input data block is provided in the working memory and a model parameter block is copied into the working memory to perform an operation on a sub-area of the input data block. The model parameters are now used to perform a single calculation step on the sub-area of the input data block. The resulting output data block of partial output data is temporarily stored in a memory space of the working memory. The procedure is then repeated for the next sub-area. This is done separately for each sub-area of the input data block in accordance with the division, so that several output data blocks distributed in the working memory are available, each with partial output data for the calculation step for computing the specific layer. These are then linked together in a calculation step designed as a concatenation layer.

In particular, the copy operation for copying the model parameter block in the working memory takes place again before each individual calculation step of the input data block, although the model parameters contained therein are identical for each processing of the relevant sub-area. It is therefore planned to share the corresponding model parameter block for all individual calculation steps during memory planning and to copy it into the working memory only once before the first tiling calculation step. The model parameter block copied there is then retained and protected in the working memory until the calculations have been completed by the individual calculation steps.

The memory operations that are normally performed before each individual tiling calculation step are then only applied during code generation before the individual tiling calculation step for processing the first section of the input data block and are omitted for the subsequent individual timing calculation steps.

Furthermore, the entire input data block can be copied to the working memory before the individual calculation steps of the tiling calculation step begin. Alternatively, only the partial areas of the input data block can be read into the working memory before each individual tiling calculation step. The model parameter block, which is saved in the working memory before the first timing calculation step, is retained.

It may be provided that when creating the memory planning rule for the particular calculation step, the rule further specifies a lifetime of the corresponding model parameter block for storing the model parameters, wherein the lifetime specifies that the model parameter block remains stored and accessible in the working memory for the duration of the execution of the individual calculation steps for the tiling calculation step.

### BRIEF DESCRIPTION OF THE DRAWINGS

Preferred embodiments are described in more detail below with reference to the accompanying drawings. The figures show:

FIG. 1 is a schematic illustration of a platform for code generation and implementation in a hardware environment;

FIG. 2 is a flowchart illustrating the code generation method for a hardware environment;

FIG. 3A is a representation of the memory allocation of the working memory during a calculation of a convolutional layer in individual calculation steps; and

FIG. 3B is another representation of the memory allocation of the working memory during a calculation of a convolutional layer in individual calculation steps.

### DETAILED DESCRIPTION

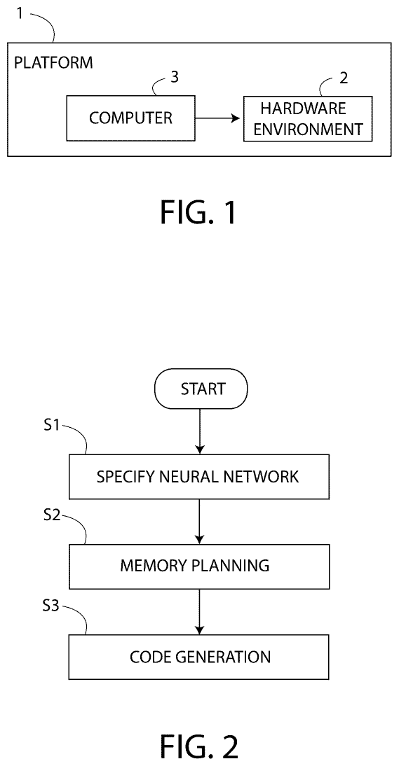

FIG. 1 shows a block diagram of a platform 1 for performing code generation and implementing a generated program code in a hardware environment 2. For example, the hardware environment corresponds to a control device having a microcontroller, microprocessor, or the like. Code generation is done on a conventional computer 3 or workstation based on the specified configuration of a neural network. Computer 3 is configured to perform memory planning and code generation, wherein memory planning first performs placement of memory spaces in the working memory for the individual calculation steps of the neural network to accommodate at least one input data block, one output data block, and at least one model parameter block. The model parameter block comprises all model parameters that are required for computing the respective calculation step for the neural network layer.

Once the code has been generated, it is transferred to the hardware environment 2, where it is implemented or executed.

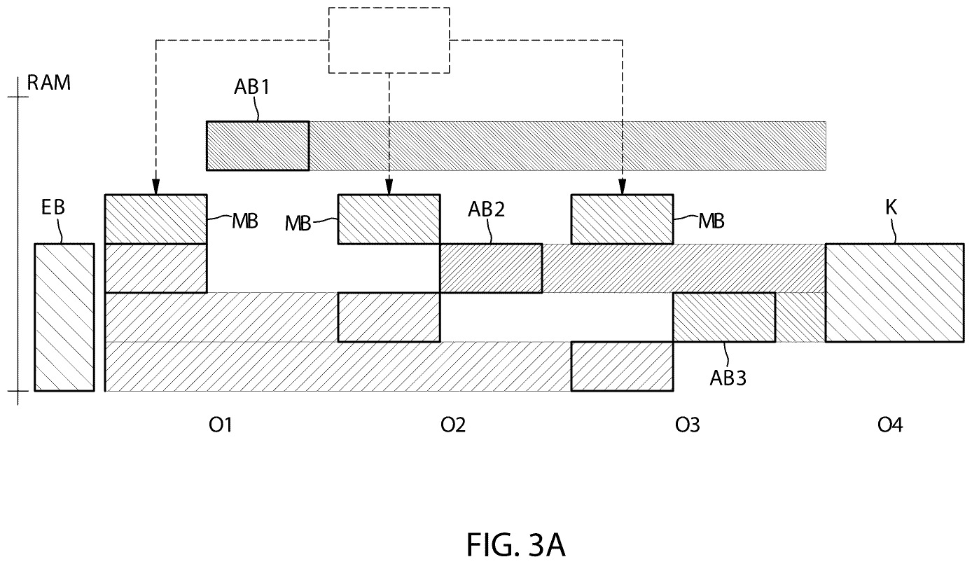

FIG. 2 shows a flowchart illustrating a method for performing memory planning and code generation for providing program code for implementing a neural network.

In step S1, the neural network with the calculation steps is specified first. The calculation steps each define the type of neural network layer to be calculated, the input data block and the resulting output data block. Model parameters can also be specified for the network layers, which are used for computing data elements of the output data block from the data elements of the input data block, depending on the type of network layer.

In step S2, the memory planning now takes place, which allocates a memory space in the working memory to each memory space that is required for input data, output data or model parameters during the execution of the calculation steps. In addition to the input and output data of the individual network layers, these are primarily the model parameters of the network layers.

Planning is carried out with the aid of an SMT planner. The planner knows the size and lifetime of the memory spaces for each calculation step of a network layer. It also manages a set of rules that describe what a valid storage plan should look like.

Let B be the set of memory spaces and b E B a single memory space with offset Ob and size Sb. The following are examples of rules that the planner manages:

$$\{ Ob \geq 0 ∧ O b + Sb \leq RAM size \vert b ∈ B \}$$

All memory spaces must be within the available memory.

$$\{ Ob 1 + Sb 1 \leq Ob 2 ∨ Ob 2 + Sb 2 \leq Ob 1 \vert b 1 , b 2 ∈ B , b 1 <> b 2 \}$$

All memory spaces must be distinct from each other.

Resolving these rules provides the storage plan.

To implement the disclosure, the model parameter block, which is used in the individual calculation steps of a tiling calculation step, is assigned to a distinct memory space. The lifetime of this model parameter block is selected so that the model parameter block is available in the working memory during the calculation of the entire tiling calculation step. This adjustment of the lifetime is sufficient to ensure that the SMT planner calculates a memory plan that can lead to code in the next step in which the disclosure is implemented.

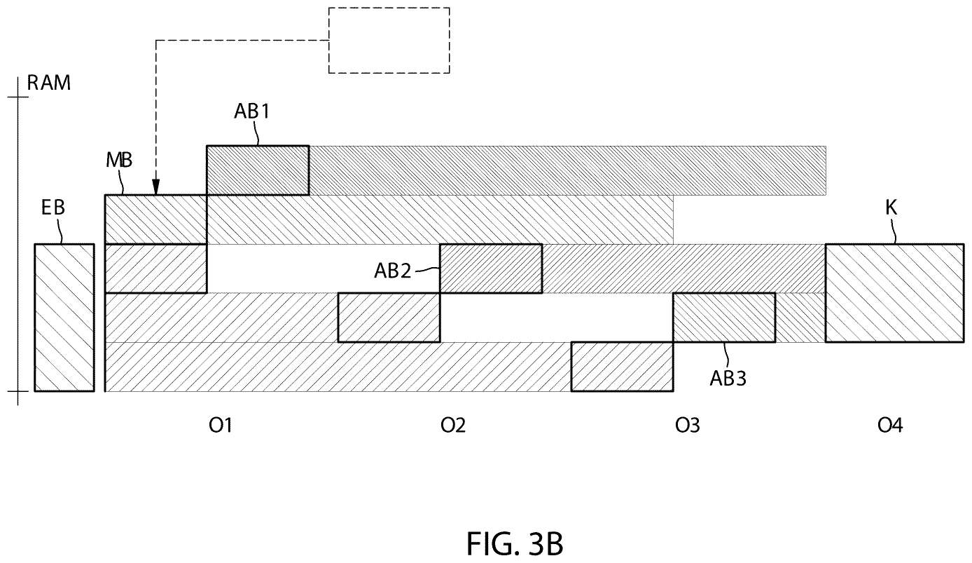

FIGS. 3A and 3B show a comparison of the results of memory planning using a conventional method and the method described above. FIG. 3A shows how model parameters of the model parameter block for each individual calculation step O1-O4 of a tiling calculation step are copied into a distinct memory space and then the respective output data blocks AB1, AB2, AB3 are each calculated from a section of an input data block EB and stored in the working memory. The output data blocks AB1, AB2, AB3 are then combined with each other in a calculation step of a concatenation layer to form the output data K.

FIG. 3B shows how model parameters of the model parameter block MB are copied into a distinct memory space only for the first individual calculation step O1 of a tiling calculation step and then the respective output data blocks AB1, AB2, AB3 are calculated from a section of an input data block EB in each case with access to the model parameters in the model parameter block MB and stored in the working memory. The output data blocks AB1, AB2, AB3 are then linked together in a calculation step of a concatenation layer.

In step S3, the code generation takes place, which provides for a single memory operation for copying the model parameter block MB for each tiling calculation step with reference to the model parameter block MB copied only once into the working memory. It must therefore be ensured in the generated code that the parameters are only copied to the working memory once.

What is claimed is:

1. A computer-implemented method for performing memory planning for code generation to generate a code for computing a neural network in a hardware environment, comprising:
providing successive calculation steps of network layers of the neural network, wherein for each calculation step the size of an input data block, an output data block and, depending on the type of calculation step, one or more model parameter blocks is determined, wherein the one or more model parameter blocks have model parameters for a respective calculation step;
determining a rule for memory planning for a specific calculation step, the model parameters are used and for which a tiling calculation step is to be provided, which provides that the tiling calculation step provides for performing a tiling for the specific calculation step in a plurality of individual calculation steps for processing the input data of a respective section of the input data block (EB), wherein the rule specifies that the model parameters for all individual calculation steps are stored in a specified memory space;
performing memory planning, in which the memory space of the respective input data block, output data block, and model parameter block is determined in the working memory for each calculation step, taking into account the determined rules; and
performing code generation, wherein the model parameter block is copied into the working memory only before executing the first individual calculation step, and the calculations of the remaining individual calculation steps are performed using the model parameters in the model parameter block.

2. The method according to claim 1, wherein performing the memory planning comprises applying an optimization method in which the target function takes into account minimizing the total memory requirement in the working memory.

3. The method according to claim 1, wherein:
when creating the rule for memory planning for the specific calculation step, the rule further specifies a lifetime of the corresponding model parameter block for storing the model parameters, and
the lifetime specifies that the model parameter block remains stored and accessible in the working memory for the duration of the execution of the individual calculation steps for the tiling calculation step.

4. The method according to claim 1, wherein the specific calculation step for which tiling is applied comprises an element-wise operation, a convolutional layer or a pooling layer calculation.

5. A device for performing the method according to claim 1.

6. A computer program product comprising commands which, when the program is executed by at least one data processing device, cause the data processing device to perform the steps of the method according to claim 1.

7. A machine-readable storage medium comprising commands which, when executed by at least one data processing device, cause the data processing device to perform the steps of the method according to claim 1.
